(19) United States
(12) Patent Application Publication
(10) Pub. No.: US 2018/0255816 A1
(43) Pub. Date: Sep. 13, 2018

(54) SWEETENERS HAVING ENHANCED ORGANOLEPTIC PROPERTIES

(71) Applicant: CORNELL UNIVERSITY, Ithaca, NY (US)

(72) Inventors: Samriddh MUDGAL, Lakeland, FL (US); Syed S.H. RIZVI, Ithaca, NY (US); Gerald FEIGENSON, Ithaca, NY (US)

(73) Assignee: CORNELL UNIVERSITY, Ithaca, NY (US)

(21) Appl. No.: 15/768,554

(22) PCT Filed: Oct. 17, 2016
(86) PCT No.: PCT/US2016/057414

§ 371 Date: Apr. 15, 2018

Related U.S. Application Data
(60) Provisional application No. 62/242,527, filed on Oct. 16, 2015.

(51) Int. Cl. A23L 27/30; A23L 2/60; A23L 2/66; A23L 27/00

(52) U.S. Cl. CPC A23L 27/36; A23L 2/60; A23V 2002/00; A23L 27/86; A23L 2/66

(57) ABSTRACT

Disclosed herein are inclusion complexes of sweeteners which result in improved organoleptic properties, for example, reduced bitterness. Further disclosed are methods for making the disclosed inclusion complexes.

### CROSS-REFERENCE TO RELATED APPLICATIONS

This application claims priority benefit of U.S. Provisional Patent Application Ser. No. 62/242,527, filed Oct. 16, 2015, the disclosure of which is hereby incorporated by reference herein in its entirety.

### FIELD OF THE DISCLOSURE

The present disclosure relates to, inter alia, sweeteners having enhanced organoleptic properties, methods for preparing the improved sweeteners, and beverages and foodstuffs containing the improved sweeteners.

### BACKGROUND OF THE INVENTION

Stevia rebaudiana, also known as stevia, has become more widely used in food as a non-nutritive sweetener. The compound steviol exists in various forms of a glycoside (a molecule containing glucose and an aglycone residue), which is perceived as having up to 300 times the sweetness of sugar.

Some of the tongue's bitter receptors, however, react to the aglycones and different steviol molecules demonstrate different sweetness/bitterness profiles. For instance, rebaudioside D comprises five glucose molecules and is around five times sweeter and two-thirds less bitter than dulcoside A which has just two glucose molecules.

The sweetness of stevia also has a slower onset and longer duration than sugar; both of these attributes are undesirable, limiting their application in many foods. In addition, although steviol glycosides have a clean, sweet taste in aqueous solution, their taste profile changes when evaluated in food or beverage systems because the sweetness equivalency is highly system dependent.

The present invention is directed to overcoming these and other deficiencies in the art.

### SUMMARY OF THE INVENTION

Disclosed herein are, inter alia, inclusion complexes of sweeteners that result in improved organoleptic properties of the sweeteners (e.g., reduced bitterness). Further disclosed are methods of making the disclosed inclusion complexes, methods for improving the organoleptic properties of sweeteners, and beverages and foodstuffs containing the sweeteners having such inclusion complexes.

In one aspect, the present disclosure provides an inclusion complex comprising: (a) a sweetener having at least one hydrophobic region; and (b) a globular protein having one or more hydrophobic binding sites, where at least one of the hydrophobic regions of the sweetener forms an inclusion complex with at least one of the protein hydrophobic binding sites, thereby providing improvement in at least one organoleptic property of the sweetener.

In another aspect, the present disclosure provides a method for improving at least one organoleptic property of a sweetener, where the method comprises combining the sweetener with a globular protein under conditions effective to improve at least one organoleptic property of the sweetener.

In another aspect, the present disclosure provides a method for improving at least one organoleptic property of a sweetener, where the method comprises combining a sweetener having at least one hydrophilic region and at least one hydrophobic region with a globular protein having at least one hydrophobic binding site capable of binding to the sweetener and forming an inclusion complex, thereby improving at least one organoleptic property of the sweetener.

In another aspect, the present disclosure provides a method for controlling the binding of a sweetener to an organoleptic taste receptor, where the method comprises combining the sweetener with a globular protein.

In another aspect, the present disclosure provides a beverage comprising: (i) an inclusion complex and (ii) an aqueous carrier, where the inclusion complex comprises: (a) a sweetener having at least one hydrophobic region; and (b) a globular protein having one or more hydrophobic binding sites.

In another aspect, the present disclosure provides a foodstuff comprising an inclusion complex, where the inclusion complex comprises: (a) a sweetener having at least one hydrophobic region; and (b) a globular protein having one or more hydrophobic binding sites.

In accordance with various aspects, the present disclosure provides means for improving the taste profile of various sweeteners. For example, as described in more detail herein, the present disclosure describes the improvement of the taste profile of steviol glycosides through hydrophobically induced structural modification by masking the bitter aftertaste and imparting a more sugar-like taste characteristic.

These and other objects, features, and advantages of this invention will become apparent from the following detailed description of the various aspects of the invention taken in conjunction with the accompanying drawings.

### BRIEF DESCRIPTION OF THE DRAWINGS

FIG. 1A is the pre-saturated 600 MHz ¹H NMR spectrum of a D₂O solution of the inclusion complex formed from 1 mM rebaudioside A and 20 μM bovine serum albumin (BSA). The spectrum was obtained at 40° C. and pH 3. FIG. 1B is the saturation transfer difference (STD) spectrum of the conjugate in FIG. 1A. The aromatic protein resonances at 7.19 ppm were generated internally with off-resonance saturation at 30 ppm. FIG. 1C is the STD spectrum of a control sample as a D₂O solution of 1 mM Rebaudioside A at 40° C. and pH 3 acquired under identical conditions as the spectrum in FIG. 1B.

FIG. 2A is the pre-saturated 600 MHz ¹H NMR spectrum of a 2 mM rebaudioside A and 50 μM BSA in filtered orange juice with 10% D₂O at 25° C. FIG. 2B is the STD spectrum of 2 mM rebaudioside A in filtered orange juice with 10% D₂O at 25° C. with on- and off-resonance saturation at 8.56 and 31 ppm, respectively. Sub-spectra were acquired independently and subtracted during processing. FIG. 2C is the STD spectrum of 2 mM rebaudioside A and 50 μM BSA in filtered orange juice with 10% D₂O at 25° C. acquired under similar conditions as the spectrum in FIG. 2B. FIG. 2D is the pre-saturated ¹H NMR spectrum of a sample containing 0.5 mM rebaudioside A at 40° C. and pH 3.

FIG. 3A shows the changes in observed chemical shifts and line-widths for the titration of rebaudioside A with BSA at 40° C. and pH 3.0. FIG. 3B shows the changes in observed chemical shifts and line-widths for the titration of rebaudioside A with BSA at 40° C. and pH 6.7. FIG. 3C shows the changes in observed chemical shifts and line-widths for the titration of rebaudioside A with BSA at 4° C. and pH 6.7. FIG. 3D shows the changes in observed chemical shifts and line-widths for the titration of 0.88 mM BSA with varying concentrations of rebaudioside A at 40° C. and pH 6.7.

FIGS. 4A-C are plots of the mole fraction of bound rebaudioside A (0.5 mM) with increasing concentrations of BSA. FIG. 4A data were obtained at 40° C./pH 3, FIG. 4B data were obtained at 40° C./pH 6.7 and FIG. 4C data were obtained at 4° C./pH 6.7.

FIG. 5 is an epitope map of rebaudioside A indicating the slopes of magnetization (R) acquired from saturation transfer difference (STD) obtained from a sample containing 1 mM Rebaudioside A and 20 μM BSA at 40° C. and pH 3. The peak intensities were fit into the first order-kinetics equation y=C+A(1−e^{-Rx}). For a given Rebaudioside A proton, higher values of R represent a faster rate of magnetization transfer from protein protons, indicating intimate contact with BSA in the rebaudioside A—BSA inclusion complex.

FIG. 6 is a partial spectrum indicating the peak assignments listed below in Table IV.

FIG. 7 is the formula of rebaudioside A indicating the atom assignments listed in Table IV.

FIG. 8A is the solvent suppressed (WET) ¹H NMR spectrum of a sample containing 1 mM rebaudioside A and 20 μM β-lactoglobulin at 40° C. and pH 3. FIG. 8B is the STD spectrum of the same sample. Separate FIDs were stored with on-resonance saturation at 7.19 ppm and off-resonance saturation at −15 ppm.

### DETAILED DESCRIPTION

The present disclosure provides, inter alia, inclusion complexes of sweeteners that result in improved organoleptic properties of the sweeteners (e.g., reduced bitterness). The present disclosure also provides methods of making the disclosed inclusion complexes, methods for improving the organoleptic properties of sweeteners, and beverages and foodstuffs containing the sweeteners having such inclusion complexes. These aspects of the present disclosure are further discussed herein.

In this specification and in the claims that follow, reference will be made to a number of terms, which shall be defined to have the following meanings:

All percentages, ratios and proportions herein are by weight, unless otherwise specified. All temperatures are in degrees Celsius (° C.) unless otherwise specified.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise.

The antecedent “about” indicates that the values are approximate. For example the range of “about 1% to about 50% by weight” indicates that the values are approximate values. The range of “about 1% to about 50% by weight” includes approximate and specific values, e.g., the range includes about 1%, 1%, about 50% and 50%.

When a range is described, the range includes both the endpoints of the range as well as all numbers in between. For example, “between 1% and 10%” includes 1%, 10% and all amounts between 1% and 10%. Likewise, “from 1% to 10%” includes 1%, 10% and all amounts between 1% and 10%.

The terms “organoleptic” and “organoleptic property” relate to the properties of a compound, composition, inclusion complex, conjugate, molecule, or sweetener that are experienced by people through their senses. For example, in the context of a sweetener, organoleptic properties can include, without limitation, sweetness and bitterness. More particularly, the present disclosure relates to the organoleptic properties associated with taste. As used herein, organoleptic and organoleptic properties of a sweetener can also be described in terms of the taste profile of the sweetener. Examples of improved organoleptic properties of a sweetener can include, without limitation, a reduction in bitterness, a reduction in astringent and liquorice notes, slower onset of sweetness, a reduction in lingering sweetness, a reduction in lingering bitterness, a reduction in bitter aftertaste, a reduction in metallic aftertaste, a reduction in chemical and synthetic aftertaste, and a combination thereof.

As discussed, improving one or more organoleptic property of a sweetener results in the improvement of the taste profile of that sweetener. The overall taste profile of a compound, composition, inclusion complex, conjugate, molecule, and more particularly of a sweetener, is an interplay of several different tastes, whether they be bitterness, sweetness, sourness, etc. In accordance with the present disclosure, the improvement of just one organoleptic property of a sweetener can result from the interaction of at least one hydrophobic region of the sweetener with at least one hydrophobic binding site of a globular protein, which in various embodiments is achieved by embedding at least one hydrophobic region of the sweetener in at least a portion of a hydrophobic binding site (e.g., hydrophobic cavity) of the globular protein.

“Reduced bitterness” is one of the organoleptic properties that is improved by the disclosed inclusion complexes. As described herein, other non-limiting examples of organoleptic properties include astringency, licorice notes, slower onset of sweetness, lingering sweetness, lingering bitterness, bitter aftertaste, metallic aftertaste, chemical and synthetic aftertaste. Organoleptic properties are subjective and the impact on the taste receptors can vary from individual to individual. A person perceiving bitterness in a sample will have a different perception from a second person who perceives a metallic aftertaste in the same sample.

The recitation of “reduced bitterness” means that an aqueous solution containing a sweetener having at least one hydrophobic site and one or more binding agents each of which having one or more hydrophobic binding sites, will have a reduced bitterness perception to a majority of users. As stated herein, the perception of less bitterness is an organoleptic property that can vary from person to person. For example, one user may find no bitterness present, while another user may find “a little” or “slight” bitterness. The amount of bitterness, however, is reduced for the majority of users.

One organoleptic property important to taste is clean or non-lingering sweetness. Lingering sweetness is described as the perception of sweetness after an item comprising a sweetener is consumed wherein a continued perception of sweetness lingers that is perceived as an unwanted aftertaste. Solutions which have reduced astringency, licorice notes, rapid onset of sweetness, lingering sweetness, lingering bitterness, bitter aftertaste, metallic aftertaste, chemical and synthetic aftertaste are compositions having improved taste profiles.

The perception of “sweetness” and “bitterness” as it relates to the present disclosure is affected by the concentration of the sweetener, the concentration of the globular protein, the ratio of sweetener to the globular protein, the pH of the solution, the temperature of the solution and the presence of any adjunct ingredients, for example, natural or artificial flavorings.

The term “globular protein” or “spheroproteins” are spherical (“globe-like”) proteins. Non-limiting examples, of suitable globular proteins are further described herein. Globular proteins or fragments of globular proteins having a binding site capable of receiving the hydrophobic section of a naturally occurring sweetener are included in the present disclosure.

The term ‘sweetener” means any sweetener for which organoleptic properties can be improved by the disclosed methods. In one embodiment, the sweetener is found in nature. For example, sucrose is a naturally occurring sweetener as is stevioside.

The terms “hydrophobic site,” “hydrophobic binding site” or “hydrophobic region” refers to portions of the sweeteners and/or the globular proteins that favorably interact with one another thereby resulting in improved organoleptic properties (e.g., reduced bitterness) and an improved taste profile (e.g., sweetness profile).

Disclosed herein are inclusion complexes, comprising: (a) a sweetener having at least one hydrophobic region; and (b) a globular protein having one or more hydrophobic binding sites, where at least one of the hydrophobic regions of the sweetener forms an inclusion complex with at least one of the protein hydrophobic binding sites, thereby providing improvement in at least one organoleptic property of the sweetener.

One aspect of the present disclosure relates to sweeteners that are steviol glycosides. In one embodiment, the disclosed steviol glycosides are obtained from the leaves of the South American plant Stevia rebaudiana (Asteraceae).

Steviol glycosides comprise a core hydrophobic diterpene “steviol” having the formula:

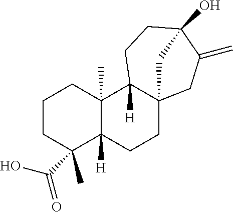

where one or more glucose units are attached to the hydroxyl and the carboxyl group. Non-limiting examples of steviol glycosides obtained from S. rebaudiana include stevioside, rebaudioside A, rebaudioside B, rebaudioside C, rebaudioside D, rebaudioside E, and dulcoside.

Stevioside has the following formula:

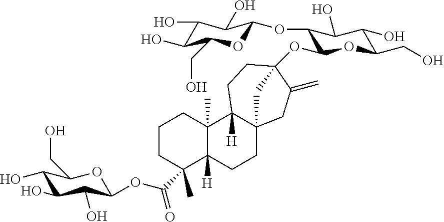

In addition to the sweeteners obtained from S. rebaudiana, the Chinese plant Rubus chingii produces rubusoside another steviol glycoside.

The diterpene steviol has dual organoleptic properties; sweetness as well as bitterness. The bitterness of the diterpene overrides any perceived sweetness. It is this hydrophobic diterpene that is bound to a hydrophobic binding site on the globular proteins.

The globular protein can be any intact protein or any sequence or section of either a globular protein or other protein which is capable of binding with the diterpene unit of the disclosed steviol glycosides. As such, proteins or fractions thereof are also referred to as “binding agents.” In one embodiment the globular protein is chosen from α-globulins, β-globulins, ovalbumin, bovine serum albumin, serum albumin, human serum albumin, or lactalbumin. In another embodiment the globular protein is a mixture of two or more globular proteins. In further embodiment a portion of a globular protein is used to bind to the hydrophobic diterpene unit.

In one example of this aspect the binding agent is bovine serum albumin. In a further example the binding agent is an α-globulin, non-limiting examples of which include α₁-antitrypsin, alpha 1-antichymotrypsin, orosomucoid, serum amyloid A, alpha 1-lipoprotein, haptoglobin, alpha-2u globulin, α₂-macroglobulin, ceruloplasmin, thyroxine-binding globulin, alpha 2-antiplasmin, protein C, alpha 2-lipoprotein, and angiotensinogen.

In another example the binding agent is an β-globulin, non-limiting examples of which include beta-2 microglobulin, plasminogen, angiostatins, properdin, and transferrin. In yet another example the binding agent is ovalbumin. In a still further example the binding agent is serum albumin. In a yet further example the binding agent is human serum albumin. In a still yet further example the binding agent is lactalbumin. In a yet still further example two or more of the recited binding agents are used.

In a further example the globular protein can be derived from a plant source. Non-limiting examples of plants from which the globular protein can be derived include soy protein, chlorella protein, hemp seed protein, legume protein, and grain protein. As such, any globular protein derived from a plant source is suitable for use in forming the disclosed inclusion complexes.

In this aspect the millimolar (mM) ratio of the to the binding agent to the steviol glycoside is from about 1 mM:1 mM to about 1 mM:250 mM or from about 5 mM:1 mM to about 1 mM:1 mM (including 4:1; 2:1 etc). In one embodiment the ratio is from about 1:1 to about 1:10. In another embodiment the ratio is from about 1 mM:2 mM to about 1 mM:10 mM. In a further embodiment the ratio is from about 1 mM:5 mM to about 1 mM:20 mM. In a still further embodiment the ratio is from about 1 mM:1 mM to about 1 mM:5 mM. In another further embodiment the ratio is from about 1 mM:1 mM to about 1 mM:250 mM.

A non-limiting embodiment of a solution comprising 500 μM rebaudioside A can comprise a binding agent: steviol glycoside ratio of 1:250, for example, BSA (binding agent) concentration of 2 μM or about 6.6 mg in 50 ml solution. A further non-limiting embodiment of a solution comprising binding agent:steviol glycoside ratio of 5:1 would have a BSA concentration of 2500 μM or about 8.25 grams in 50 mL solution.

In yet further embodiment the ratio is from about 1 mM:5 mM to about 1:10. In a yet still further embodiment the ratio is from about 1:2 to about 1:8. In a still another embodiment the ratio is from about 1:1 to about 1:3. The ratio of the binding agent to the steviol glycoside can have any value from 1:1 to 1:20, for example, 1:1, 1:2, 1:3, 1:4, 1:5, 1:6, 1:7, 1:8, 1:9, 1:10, 1:11: 1:12, 1:13, 1:14, 1:15, 1:16, 1:17, 1:18, 1:19 and 1:20. Also any fractional amounts can be used. It is convenient to express, for example, the ratio 1:2.5 as 2:5 and the ratio 1:1.33 as 3:4.

Further to the present aspect of the disclosure are aqueous solutions of the inclusion complexes. For example a composition, comprising: (i) an inclusion complex, comprising: (a) a sweetener having at least one hydrophobic region; and (b) a globular protein having one or more hydrophobic binding sites; and (ii) a carrier, wherein at least one of the hydrophobic regions of the sweetener forms an inclusion complex with at least one of the protein hydrophobic binding sites thereby providing reduced bitterness.

A further aspect of the disclosure relates to compositions, comprising: (i) an inclusion complex, comprising: (a) a sweetener having at least one hydrophobic region; and (b) a globular protein having one or more hydrophobic binding sites; and (ii) a carrier, wherein at least one of the hydrophobic regions of the sweetener forms an inclusion complex with at least one of the protein hydrophobic binding sites, thereby providing a sweetener having at least one improved organoleptic property.

The solubility of the inclusion complex can be affected by the carrier and the characteristics of the solution, for example, pH. The pH of an aqueous solution of the inclusion complex can be from about 2.5 to about 8. The solution, however, can have any pH from about 2.5 to 8, for example, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, and 8.

In one embodiment the carrier is water. In another embodiment the carrier is a carbonated liquid. In a further embodiment the carrier is juice, for example, orange juice, lemon juice, lime juice, apple juice, apricot juice, blueberry juice, peach juice, pineapple juice, cranberry juice, or mixtures thereof.

The amount of the inclusion complex present in a beverage is based upon the amount of the sweetener present. In one embodiment the amount of sweetener present is from about 100 mg/liter to about 800 mg/liter. Based upon the choice of sweetener, globular protein, the temperature and pH, the bound sweetener which is an integral part of inclusion complex will be in equilibrium with the unbound sweetener. The concentration of inclusion complex present can be such that the percent of bound Rebaudioside A is anywhere from about 1% to about 80% and still provide improved organoleptic properties. In one embodiment the percentage of the bound Rebaudioside A present is from about 20% to about 80%. In one embodiment the percentage of the bound Rebaudioside A present is from about 20% to about 60%. In another embodiment the percentage of the bound Rebaudioside A present is from about 40% to about 80%. In a further embodiment the percentage of the bound Rebaudioside A present is from about 60% to about 80%.

In still further embodiment the percentage of the bound Rebaudioside A present is from about 50% to about 70%. In yet another embodiment the percentage of the bound Rebaudioside A present is from about 30% to about 50%. In a still yet another embodiment the percentage of the bound Rebaudioside A present is from about 70% to about 80%. The concentration of inclusion complex present, i.e., the percent of sweetener that is bound to a protein can have any value from about 1% to about 80%, for example 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, or 80%.

The inclusion complex involves the reversible binding of the globular protein to the steviol diterpene. The equilibrium between bound and unbound steviol diterpene is affected by temperature, concentration and other solution chemistry factors. As the ratio of steviol glycoside to globular protein increases, for example, increasing amount of glycoside is present, the relative sweetness will increase which may be accompanied with an increase in bitterness. As important, however, is the organoleptic perception of sweetness, for example, the onset of sweetness, how “clean” the perceived sweetness changes and whether there is lingering or “after taste sweetness.”

By utilizing the present disclosure the formulator will be able to adjust the properties of any consumable food product to match the desired range of organoleptic taste properties. Because the steviol glycoside and globular protein do not degrade, compositions utilizing the present disclosure can be shelf stable.

The inclusion complex of the present disclosure can also be used in a solid formulation which contains the complex, buffers, fortifiers (Ca), flavorants, etc.

The inclusion complex of the present disclosure can be used in any suitable product such as reduced calorie, zero calorie, or diabetic beverages and food products with improved organoleptic properties. It can be used in drinks, foodstuffs, pharmaceuticals, and other products in which sugar cannot be used.

Examples of products where the inclusion complex of the present disclosure can be used as sweetener can include, without limitation, alcoholic beverages such as vodka, wine, beer, liquor, sake, etc.; natural juices, refreshing drinks, carbonated soft drinks, diet drinks, zero calorie drinks, reduced calorie drinks and foods, yogurt drinks, instant juices, instant coffee, powdered types of instant beverages, canned products, syrups, fermented soybean paste, soy sauce, vinegar, dressings, mayonnaise, ketchups, curry, soup, instant bouillon, powdered soy sauce, powdered vinegar, types of biscuits, rice biscuit, crackers, bread, chocolates, caramel, candy, chewing gum, jelly, pudding, preserved fruits and vegetables, fresh cream, jam, marmalade, flower paste, powdered milk, ice cream, sorbet, vegetables and fruits packed in bottles, canned and boiled beans, meat and foods boiled in sweetened sauce, agricultural vegetable food products, seafood, ham, sausage, fish ham, fish sausage, fish paste, deep fried fish products, dried seafood products, frozen food products, preserved seaweed, preserved meat, tobacco, medicinal products, and many others. In principal, the inclusion complex can have unlimited applications.

The inclusion complex of the present disclosure may be incorporated as a high intensity natural sweetener in foodstuffs, beverages, pharmaceutical compositions, cosmetics, chewing gums, table top products, cereals, dairy products, toothpastes and other oral cavity compositions, etc. During the manufacturing of foodstuffs, drinks, pharmaceuticals, cosmetics, table top products, chewing gum the conventional methods such as mixing, kneading, dissolution, pickling, permeation, percolation, sprinkling, atomizing, infusing and other methods can be used.

The inclusion complex of the present disclosure can be used in dry or liquid forms. It can be added before or after heat treatment of food products. The amount of the sweetener depends on the purpose of usage. It can be added alone or in the combination with other compounds. The inclusion complex of the present disclosure may be employed as the sole sweetener, or it may be used together with other naturally occurring high intensity sweeteners.

In one aspect, the present disclosure relates to a method of improving the taste profile of steviol glycosides through hydrophobically induced structural modification. In another aspect, the present invention also relates to a flavor modifying agent which masks the off-flavors such as bitter after-taste associated with steviol glycosides and imparts a more sugar-like taste characteristics to steviol glycosides. In particular, in certain aspects the present invention relates to remodeling the molecular structure of rebaudioside A by embedding the hydrophobic aglycone of rebaudioside A inside the hydrophobic cavities of selected proteins.

As described herein, the binding of the globular protein to bind the steviol glycoside is an equilibrium affected by various factors. The ability of a disclosed globular protein to bind to the hydrophobic portion of a steviol glycoside was studied by ¹H NMR. The binding of rebaudioside A having the formula:

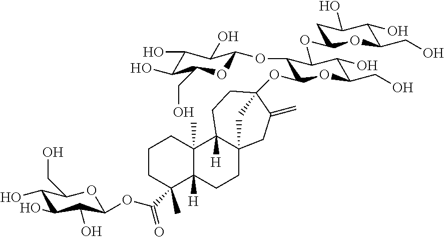

with bovine serum albumin was examined. The binding constant K_{d} at various conditions was obtained by titration of a 0.5 mM solution of rebaudioside A with 0.88 mM BSA under various conditions. FIG. 3A shows the changes in observed chemical shifts and line-widths for the titration of rebaudioside A with BSA at 40° C. and pH 3.0. FIG. 3B shows the changes in observed chemical shifts and line-widths for the titration of rebaudioside A with BSA at 40° C. and pH 6.7. FIG. 3C shows the changes in observed chemical shifts and line-widths for the titration of rebaudioside A with BSA at 4° C. and pH 6.7. FIG. 3D shows the changes in observed chemical shifts and line-widths for the titration of 0.88 mM BSA with varying concentrations of rebaudioside A 40° C. and pH 6.7.

As seen in FIG. 3B at pH 6.7 and 40° C. the titration was characterized by changes in chemical shifts and large increases in linewidths for rebaudioside A. AS seen in FIG. 3C we did not observe significant changes in chemical shift, but large increases in linewidths. FIG. 3A demonstrates that at pH 3 and 40° C. the changes in chemical shifts were similar to those at pH 6.7, but only moderate increases in linewidths were observed. In addition, the BSA signals were noticeably sharper at pH 3 than at pH 6.7, whereas temperature had only a minor effect. BSA is known to display a pH dependent tendency to self-assemble into large aggregates.

Without wishing to be limited by theory, the rate of exchange between bound and free ligands can depend on temperature, pH, binding surfaces, and presence of any titratable protons that are involved in binding. It is possible that at pH 6.7 and 4° C., the exchange of bound and free rebaudioside A is slow on the NMR timescale, i.e., the exchange rate is slower than the frequency difference between resonances of the bound and free states. Therefore the observed free rebaudioside A chemical shifts remain constant. FIG. 3B indicates that at pH 6.7 and 40° C. both chemical shift averaging and exchange broadening of rebaudioside A resonances are observed. FIG. 3A indicates that at pH 3 and 40° C., fast exchange results in significant chemical-shift averaging of free and bound rebaudioside A resonances but only moderate broadening. Table I lists the changes in observed and fitted chemical shifts of the peaks during the titration of rebaudioside A (0.5 mM) with BSA from 0.05 mM to 0.88 mM for a sample at 40° C. at pH 3. The bound NMR parameters were δ 5.2-5.42 ppm.

TABLE I
40° C. @ pH 3

| BSA | δ_{H} | Fitted δ_{H} | Fitted δ_{H} |
|---|---|---|---|
| (mM) | Observed | (upper 95%) | (lower 95%) |
| 0 | 5.49 | 5.49 | 5.49 |
| 0.05 | 5.482 | 5.486 | 5.487 |
| 0.13 | 5.476 | 5.48 | 5.484 |
| 0.25 | 5.466 | 5.47 | 5.477 |
| 0.38 | — | — | — |
| 0.51 | 5.452 | 5.45 | 5.465 |
| 0.63 | — | — | — |
| 0.76 | — | — | — |
| 0.88 | 5.439 | 5.42 | 5.446 |
| K_{d} (mM) | NA | 39-8 | 24-5 |

Table II lists the changes in observed and fitted chemical shifts of the peaks during the titration of rebaudioside A (0.5 mM) with BSA from 0.05 mM to 0.88 mM for a sample at 40° C. at pH 6.7. The bound NMR parameters were 6 4.0-5.4 ppm.

TABLE II
40° C. @ pH 6.7

| BSA | δ_{H} | Fitted δ_{H} | Fitted δ_{H} |
|---|---|---|---|
| (mM) | Observed | (upper 95%) | (lower 95%) |
| 0 | 5.486 | 5.486 | 5.486 |
| 0.05 | 5.484 | 5.484 | 5.484 |
| 0.13 | 5.481 | 5.481 | 5.481 |
| 0.25 | 5.476 | 5.475 | 5.477 |
| 0.38 | 5.471 | 5.47 | 5.472 |
| 0.51 | 5.467 | 5.464 | 5.467 |
| 0.63 | 5.459 | 5.459 | 5.463 |
| 0.76 | 5.4552 | 5.453 | 5.458 |
| 0.88 | 5.454 | 5.448 | 5.443 |
| K_{d} (mM) | NA | 280-15 | 240-13 |

Table III lists changes in the observed and fitted line width of the peaks during the titration of rebaudioside A (0.5 mM) with BSA from 0.05 mM to 0.88 mM for a sample at 4° C. at pH 6.7. The bound NMR parameters were line width (LW) 60-200 Hz.

TABLE III
4° C. @ pH 6.7

| BSA | LW | LW | LW |
|---|---|---|---|
| (mM) | Observed | (upper 95%) | (lower 95%) |
| 0 | 8.75 | 8.75 | 8.75 |
| 0.05 | 10.2 | 10.2 | 10.2 |
| 0.13 | 12.5 | 12.4 | 12.3 |
| 0.25 | 15.9 | 16.0 | 15.9 |
| 0.38 | 19.7 | 19.6 | 19.5 |
| 0.51 | 23.1 | 23.3 | 23.1 |
| 0.63 | 26.8 | 26.9 | 26.7 |
| 0.76 | 30.6 | 30.5 | 30.3 |
| 0.88 | 34.0 | 34.2 | 33.9 |
| K_{d} (mM) | NA | 40-12 | 40-12 |

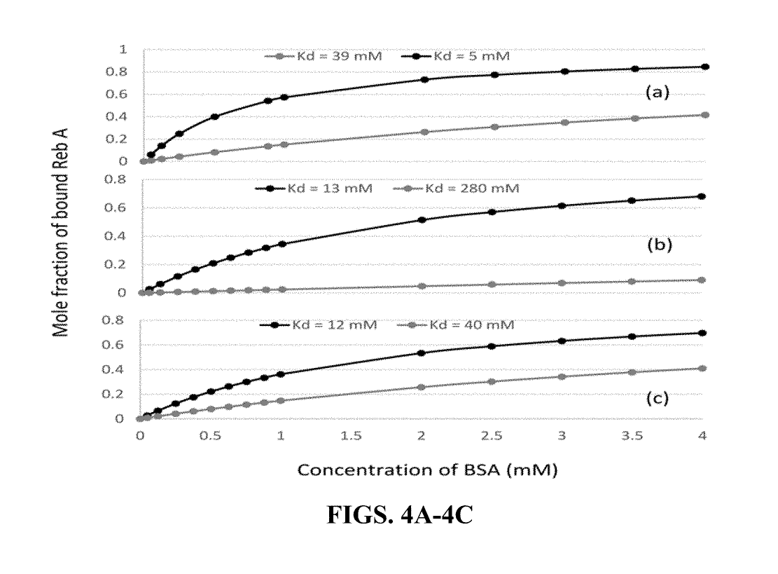

FIGS. 4A-4C are plots of the mole fraction of bound Rebaudioside A with concentration fixed at 0.5 mM with increasing BSA concentration. The lower values of K_{d} in general are indicative of fast exchange of steviol in and out of BSA binding sites, which means that the availability of glucose moieties to interact with receptors remains unaffected in rebaudioside A—BSA complex.

Identification and Characterization of Sweetener/Protein Binding

A first step is to assess binding of the protein to ligand under investigation. Saturation transfer difference (STD) NMR spectroscopy was utilized to screen ligands for binding to proteins. The method is based on the transfer of saturation from the protein to the bound ligands, which exchange into solution where they are detected as a reduction in the intensity of the free ligand signal. By subtracting the spectrum in which the protein is saturated from a spectrum without protein saturation produces a spectrum showing only the difference in which only the signals of the ligand(s) remain. This method was used to identify binding epitopes, because the ligand residues in direct contact with the protein show faster build-up of STD signals. This method involves a several-fold excess of ligand concentration over protein, allowing low mM protein concentrations to be used.

BSA is an example of a globular protein with the ability to bind to hydrophobes. Disclosed herein below are NMR spectra which demonstrates the binding of rebaudioside A and BSA.

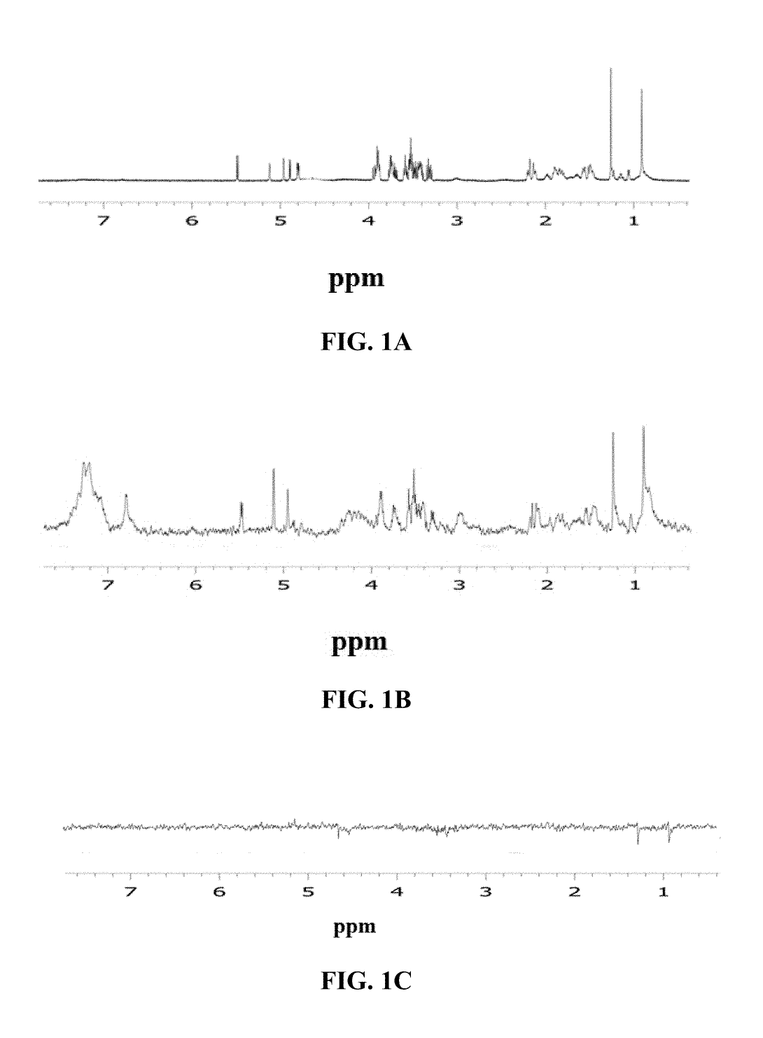

FIG. 1A is the pre-saturated 600 MHz ¹H NMR spectrum of a D₂O solution of the inclusion complex formed from 1 mM rebaudioside A and 20 μM bovine serum albumin (BSA). This spectrum was obtained at 40° C. and pH 3. FIG. 1B is the STD spectrum of 1 mM rebaudioside A and 20 μM BSA at pH 3.0 and 40° C. with saturation of the aromatic residues of BSA at 7.19 ppm showing all of the expected rebaudioside A resonances thereby indicating that rebaudioside A binds to BSA. FIG. 1C is the STD spectrum of a control sample as a D₂O solution of 1 mM rebaudioside A at 40° C. and pH 3 acquired under identical conditions as the spectrum in FIG. 1B.

In order to characterize the rebaudioside A-BSA binding interaction, the build-up of saturation transfer was evaluated by recording STD NMR spectra for saturation times ranging from 0.1 s to 3.5 s to generate build-up curves. The peak intensities were fit into the first order-kinetics equation:

y=C+A(1−e^{-Rt})

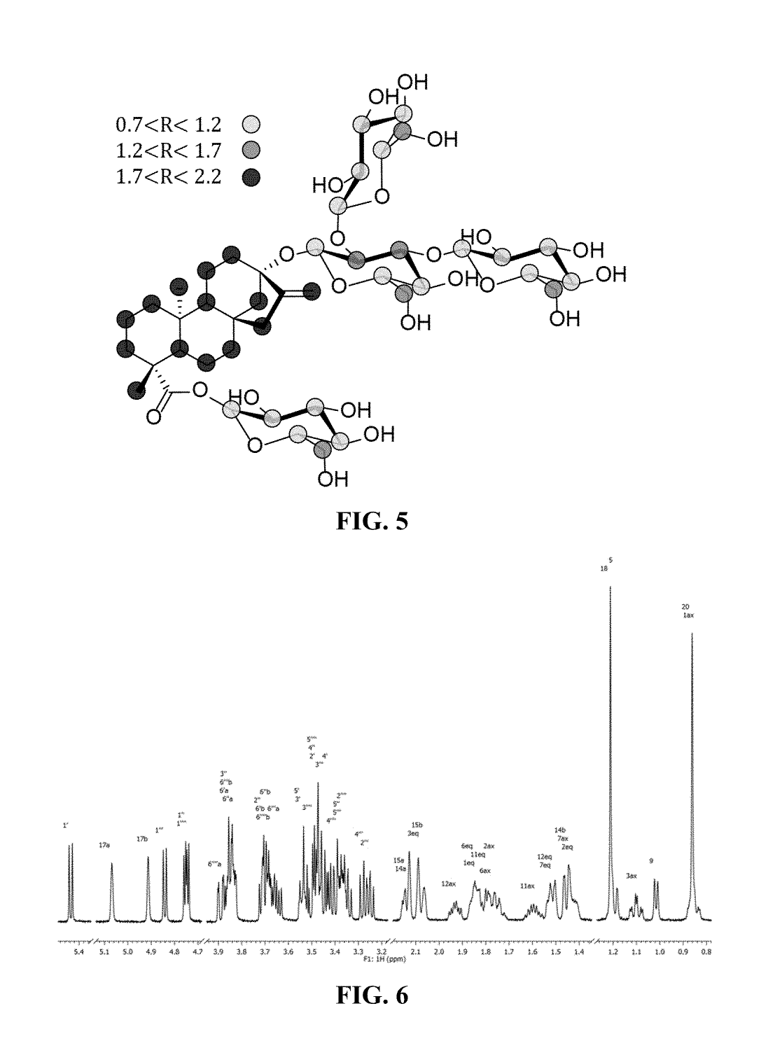

The rates of saturation build-up (R) were evaluated to determine binding epitope of rebaudioside A (Table IV and FIG. 5). For a given rebaudioside A proton, higher values of R represent a faster rate of magnetization transfer from protein protons, indicating intimate contact with protein in the rebaudioside A—BSA complex

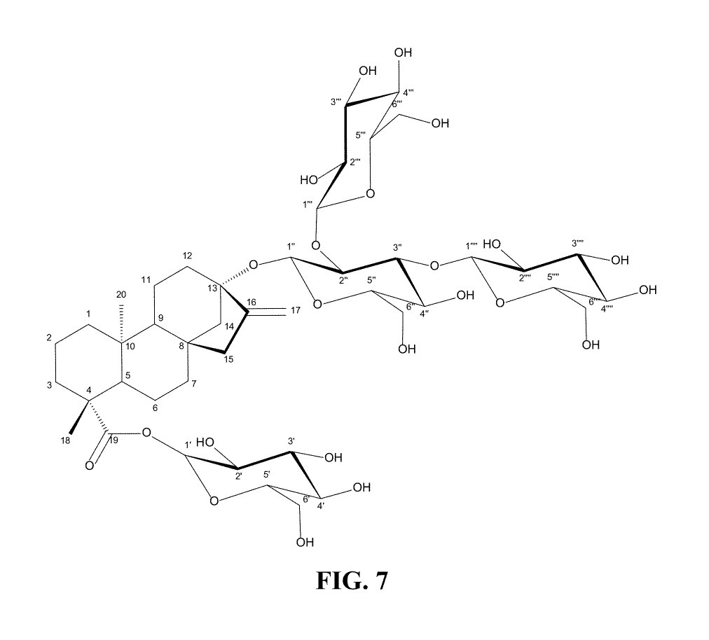

FIG. 5 is an epitope map of rebaudioside A indicating the slopes of magnetization (R) acquired from saturation transfer difference (STD) obtained from a sample containing 1 mM rebaudioside A and 20 μM BSA at 40° C. and pH 3. FIG. 6 is a partial spectrum indicating the peak assignments listed below in Table IV. FIG. 7 is the formula of rebaudioside A indicating the atom assignments listed in Table IV.

TABLE IV

| Integration Range | | STD Build- |
|---|---|---|
| (chemical shifts) | Assignment | up rate (R) |
| 0.77-0.84 | 1ax, BSA methyl | 1.9 |
| 0.86-0.89 | 1ax, 20, BSA methyl | 2.0 |
| 0.92-0.97 | BSA methyl | 1.1 |
| 0.99-1.04 | 9 | 1.9 |
| 1.08-1.15 | 3ax | 1.8^{a} |
| 1.17-1.20 | 5 | 2.1 |
| 1.20-1.24 | 18 | 1.9 |
| 1.40-1.49 | 2eq, 7ax, 14b | 2.1 |
| 1.51-1.56 | 7eq, 12eq | 2.1 |
| 1.57-1.69 | 11ax | 2.0^{a} |
| 1.74-1.82 | 2ax,6ax | 2.1^{a} |
| 1.82-1.90 | 1eq, 6eq, 11eq | 2.0^{a} |
| 2.05-2.19 | 3eq, 14a, 15a, 15b | 2.0 |
| 3.24-3.28 | 2′″ | 1.0 |
| 3.28-3.32 | 4′″ | 0.9 |
| 3.34-3.41 | 5″,5′″,2″″,4″″ | 0.9 |
| 3.43-3.47 | 4′ | 0.9 |
| 3.47-3.52 | 2′, 4″, 3′″, 3″″, 5″″ | 1.0 |
| 3.52-3.58 | 3′,5′ | 1.0 |
| 3.63-3.68 | 6′″b | 1.7 |
| 3.68-3.75 | 6′b, 2″, 6″b, 6″″b | 1.3 |
| 3.82-3.89 | 6′a, 3″, 6″a, 6′″b, 6″″a | 1.5 |
| 3.89-3.93 | 6″″a | 1.4 |
| 4.75-4.78 | 1″, 1″″ | 0.8^{a} |
| 4.83-4.88 | 1′″ | 0.8 |
| 4.91-4.95 | 17b | 1.8 |
| 5.06-5.10 | 17a | 2.1 |
| 5.43-5.47 | 1′ | 1.1 |

^{a}Peak intensities were very low, but clear exponential build-up was observed. Background areas without RebA peaks showed only random intensity fluctuations.

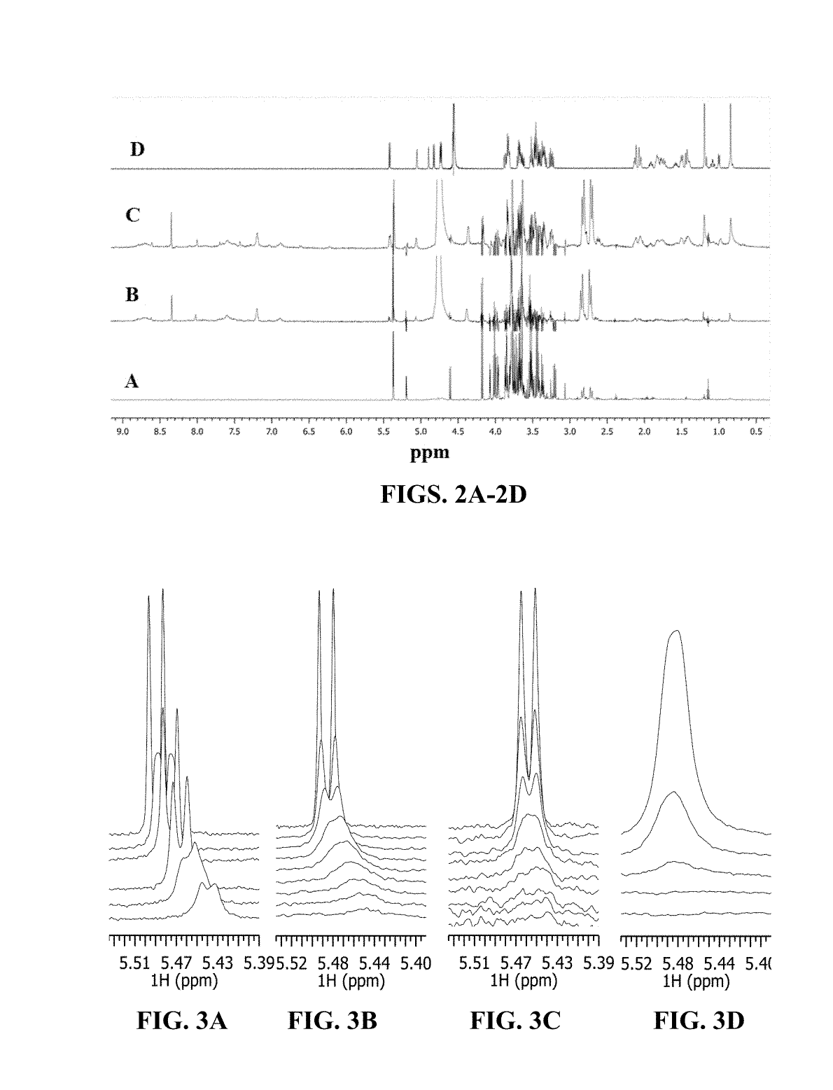

FIG. 2A is the pre-saturated 600 MHz ¹H NMR spectrum of a 2 mM rebaudioside A and 50 μM BSA in filtered orange juice with 10% D₂O at 25° C. A STD spectrum (FIG. 2B) of 2 mM rebaudioside A and 50 μM BSA in filtered orange juice with on- and off-resonance saturation at 8.56 and 31 ppm, respectively was recorded to validate the stability of rebaudioside A—BSA complex in a natural and complex food matrix. FIG. 2D is the pre-saturated ¹H NMR spectrum of a sample containing 0.5 mM rebaudioside A at 40° C. and pH 3 to establish the specificity of BSA binding to rebaudioside A. The sample with BSA showed strong saturation transfer to rebaudioside A and citric acid (2.83 and 2.71 ppm) resonances. Sub-spectra were acquired independently and subtracted during processing. FIG. 2C is the STD spectrum of 2 mM rebaudioside A and 50 μM BSA in filtered orange juice with 10% D₂O at 25° C. acquired under similar conditions as the spectrum in FIG. 2B.

The control sample without BSA (FIG. 2D) showed similar levels of saturation transfer for citric acid resonances, but strongly reduced transfer to rebaudioside A signals. Raw orange juice contains about 0.7 wt % protein and 10 wt % carbohydrates including 0.2 wt % dietary fiber. The main fiber component is pectin, some of which is methylated at the carboxylic acid. At least some pectin is known to exist as protein-pectin complex. Since on-resonance saturation was performed at 8.56 ppm—well outside the chemical shift range for carbohydrates—all observed STDs are likely to be mediated by proteins. Therefore, we attribute the observed saturation transfer to citric acid, both in the presence and absence of BSA, to its binding to pectin-protein complexes in solution. The weak saturation transfer for rebaudioside A indicates that it also binds to soluble proteins or pectin protein complexes, either via hydrophobic interactions with the steviol or hydrogen bonding between the glucose residues and pectin. The large enhancement of rebaudioside A STD signals upon the addition of BSA indicates that specific binding between Rebaudioside A and BSA occurs even in a complex food matrix such as orange juice.

The following compositions were formulated and tested for their organoleptic properties through a paired comparison test by 5 panelists. Table V provides the results of the taste panel.

TABLE V

| Composition | Concentration | Quality |
|---|---|---|
| Rebaudioside | 25 mg in 50 mL | Slow onset of sweetness |
| A | (500 ppm) | followed by lingering |
| | | sweetness and bitter after taste |
| Rebaudioside | 25 mg/8.3 mg | Negligible bitter after taste |
| A/BSA | BSA in 50 mL | with no lingering |
| | | sweetness |

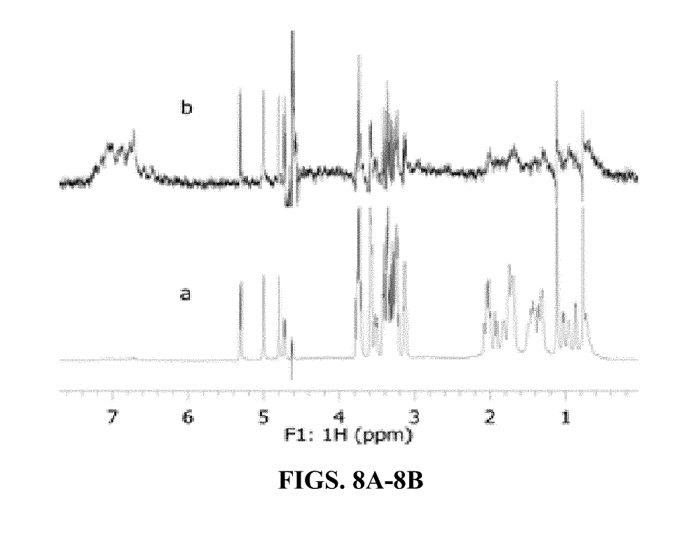

As in the example of rebaudioside A binding to BSA, FIGS. 8A and 8B demonstrate that rebaudioside A is capable of binding to β-lactoglobulin. FIG. 8A is the solvent suppressed (WET) ¹H NMR spectrum of a sample containing 1 mM rebaudioside A and 20 μM β-lactoglobulin at 40° C. and pH 3. FIG. 8B is the STD spectrum of the same sample. Separate FIDs were stored with on-resonance saturation at 7.19 ppm and off-resonance saturation at −15 ppm.

Other advantages which are obvious and which are inherent to the disclosure will be evident to one skilled in the art. It will be understood that certain features and sub-combinations are of utility and may be employed without reference to other features and sub-combinations. This is contemplated by and is within the scope of the claims. Since many possible embodiments may be made of the disclosure without departing from the scope thereof, it is to be understood that all matter herein set forth or shown in the accompanying drawings is to be interpreted as illustrative and not in a limiting sense.

1. An inclusion complex, comprising:
(a) a sweetener having at least one hydrophobic region; and
(b) a globular protein having one or more hydrophobic binding sites;
wherein at least one of the hydrophobic regions of the sweetener forms an inclusion complex with at least one of the protein hydrophobic binding sites, thereby providing improvement in at least one organoleptic property of the sweetener.

2. The complex according to claim 1, wherein the sweetener is a steviol glycoside.

3. The complex according to claim 1, wherein the sweetener is chosen from stevioside, rebaudioside A, rebaudioside B, rebaudioside C, rebaudioside D, rebaudioside E, rubusoside, dulcoside, or a mixture thereof.

4. The complex according to claim 1, wherein the sweetener is stevioside.

5. The complex according to claim 1, wherein the sweetener is rebaudioside A.

6. The complex according to claim 1, wherein the globular protein is a serum globulin chosen from α-globulins, β-globulins, γ-globulin, an ovalbumin, serum albumin, human serum albumin, lactalbumin, bovine serum albumin, or a mixture thereof.

7. The complex according to claim 1, wherein the α-globulin is chosen from α₁-antitrypsin, alpha 1-antichymotrypsin, orosomucoid, serum amyloid A, alpha 1-lipoprotein, haptoglobin, alpha-2u globulin, α₂-macroglobulin, ceruloplasmin, thyroxine-binding globulin, alpha 2-antiplasmin, protein C, alpha 2-lipoprotein, or angiotensinogen.

8. The complex according to claim 1, wherein the β-globulin is chosen from beta-2 microglobulin, plasminogen, angiostatins, properdin, or transferrin.

9. The complex according to claim 1, wherein the globular protein is bovine serum albumin.

10. The complex according to claim 1, wherein an aqueous solution of the complex is stable at a pH of from about 2.5 to about 8.

11. The complex according to claim 1, wherein the sweetener has at least one hydrophilic region and at least one hydrophobic region.

12. The complex according to claim 11, wherein the globular protein comprises at least one hydrophobic binding site capable of binding to at least one hydrophobic region of the sweetener.

13. The complex according to claim 11, wherein the hydrophobic region of the sweetener is the diterpene steviol.

14. (canceled)

15. The complex according to claim 1, wherein the improved organoleptic property is selected from the group consisting of a reduction in bitterness, a reduction in astringent and liquorice notes, slower onset of sweetness, a reduction in lingering sweetness, a reduction in lingering bitterness, a reduction in bitter aftertaste, a reduction in metallic aftertaste, a reduction in chemical and synthetic aftertaste, and a combination thereof.

16. (canceled)

17. (canceled)

18. A method for improving at least one organoleptic property of a sweetener, said method comprising combining a sweetener having at least one hydrophilic region and at least one hydrophobic region with a globular protein having at least one hydrophobic binding site capable of binding to the sweetener and forming an inclusion complex, thereby improving at least one organoleptic property of the sweetener.

19-28. (canceled)

29. A method for controlling the binding of a sweetener to an organoleptic taste receptor, said method comprising combining the sweetener with a globular protein.

30. The method according to claim 29, wherein the organoleptic taste receptor is the bitterness receptor.

31. (canceled)

32. A beverage, comprising:
(i) an inclusion complex according to claim 1,
(ii) an aqueous carrier.

33. (canceled)

34. (canceled)

35. The beverage according to claim 32, wherein the carrier is chosen from water, orange juice, lemon juice, lime juice, apple juice, apricot juice, blue berry juice, peach juice, pineapple juice, cranberry juice, or mixtures thereof.

36. A foodstuff comprising an inclusion complex according to claim 1.
